(19) United States
(12) Patent Application Publication
(10) Pub. No.: US 2024/0199030 A1
(43) Pub. Date: Jun. 20, 2024

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventor: Sho Tamura, Tokyo (JP)

(21) Appl. No.: 18/540,964

(22) Filed: Dec. 15, 2023

(30) Foreign Application Priority Data
Dec. 20, 2022 (JP) 2022-203047

(51) Int. Cl. B60W 40/06; B60W 50/14

(52) U.S. Cl. CPC B60W 40/06; B60W 50/14; B60W 30/12; B60W 2552/53; B60W 2556/40; B60W 2710/20; B60W 2720/10

(57) ABSTRACT

According to an embodiment, a vehicle control device includes a travel controller configured to control traveling of a vehicle on a runway decided on according to first information based on an output of a detection device obtained by detecting a surrounding situation of the vehicle and second information based on map information, a runway estimator configured to estimate the runway of the vehicle on the basis of the first information and the second information, and a runway decider configured to decide on the runway of the vehicle on the basis of the first information, the second information, and runway estimation information about the runway of the vehicle estimated by the runway estimator.

### CROSS-REFERENCE TO RELATED APPLICATION

Priority is claimed on Japanese Patent Application No. 2022-203047, filed Dec. 20, 2022, the content of which is incorporated herein by reference.

### BACKGROUND

### Field of the Invention

The present invention relates to a vehicle control device, a vehicle control method, and a storage medium.

### Description of Related Art

In recent years, efforts to provide access to sustainable transportation systems have been increasingly active in consideration of vulnerable individuals among participants in transportation. In pursuit of this realization, research and development on driving assistance technology are being emphasized to further improve the safety and convenience of transportation. In relation to this, self-position estimation technology for improving the quality of automated travel operation of a mobile object by calculating a reliability degree in consideration of a plurality of selected self-positions is known (for example, Japanese Unexamined Patent Application, First Publication No. 2022-125563).

### SUMMARY

Meanwhile, in driving assistance technology, when the runway of a vehicle is estimated using information recognized by a detection device that recognizes a surrounding situation and information acquired from map information on the basis of a position of the vehicle detected by a position sensor, because there are cases where actual road situations are different from map information due to an influence of road construction, bad maintenance, or the like and a runway recognized by the detection device is recognized to be different from an actual runway due to an influence of a change in road situations such as tunnels and bifurcations, there is a problem that it is difficult to accurately acquire the runway of the vehicle.

In order to solve the above problems, an objective of an aspect of the present invention is to provide a vehicle control device, a vehicle control method, and a storage medium that can improve the accuracy of the runway decision of a vehicle. In turn, it will contribute to the development of a sustainable transportation system.

A vehicle control device, a vehicle control method, and a storage medium according to the present invention adopt the following configurations.

(1): According to an aspect of the present invention, there is provided a vehicle control device including: a travel controller configured to control traveling of a vehicle on a runway decided on according to first information based on an output of a detection device obtained by detecting a surrounding situation of the vehicle and second information based on map information: a runway estimator configured to estimate the runway of the vehicle on the basis of the first information and the second information; and a runway decider configured to decide on the runway of the vehicle on the basis of the first information, the second information, and runway estimation information about the runway of the vehicle estimated by the runway estimator.

(2): In the aspect (1), the runway estimator estimates the runway of the vehicle when a deviation degree between the first information and the second information is greater than or equal to a threshold value.

(3): In the aspect (1), the vehicle control device further includes a learner configured to generate a runway estimation model in which the first information and the second information are input and the runway estimation information is output on the basis of the first information, the second information, and true value data, wherein the runway estimator estimates the runway of the vehicle based on the first information and the second information using the runway estimation model.

(4): In the aspect (1), the first information includes information of a first marking for defining a travel lane of the vehicle recognized on the basis of an output of the detection device, and the second information includes information of a second marking for defining the travel lane of the vehicle acquired from the map information on the basis of position information of the vehicle.

(5): In the aspect (1), the runway estimator estimates the runway of the vehicle on the basis of the first information, the second information, and at least one of a travel situation and vehicle model information of the vehicle.

(6): In the aspect (2), the travel controller executes driving control for controlling one or both of steering and a speed of the vehicle, the driving control includes a first driving mode and a second driving mode having a heavier task imposed on a driver of the vehicle than the first driving mode or having a lower assistance degree for the driver than the first driving mode, and the travel controller switches the driving mode from the first driving mode to the second driving mode when the deviation degree greater than or equal to a threshold value has continued for a prescribed period of time or more in a state in which the first driving mode is being executed.

(7): In the aspect (6), the vehicle control device further includes a notification controller configured to notify a driver of the vehicle of control content in the travel controller, wherein the notification controller changes content whose notification is provided to the driver in accordance with switching of the driving mode when the deviation degree greater than or equal to the threshold value has continued for the prescribed period of time or more.

(8): In the aspect (3), the learner relearns the runway estimation model using the runway of the vehicle estimated by the runway estimator and a runway on which the vehicle has actually traveled.

(9): According to an aspect of the present invention, there is provided a vehicle control method including: controlling, by a computer, traveling of a vehicle on a runway decided on according to first information based on an output of a detection device obtained by detecting a surrounding situation of the vehicle and second information based on map information: estimating, by the computer, the runway of the vehicle on the basis of the first information and the second information: and deciding, by the computer, on the runway of the vehicle on the basis of the first information, the second information, and runway estimation information about the estimated runway of the vehicle.

(10): According to an aspect of the present invention, there is provided a computer-readable non-transitory storage medium storing a program for causing a computer to: control traveling of a vehicle on a runway decided on according to first information based on an output of a detection device obtained by detecting a surrounding situation of the vehicle and second information based on map information: estimate the runway of the vehicle on the basis of the first information and the second information; and decide on the runway of the vehicle on the basis of the first information, the second information, and runway estimation information about the estimated runway of the vehicle.

According to the above-described aspects (1) to (10), it is possible to improve the runway decision of a vehicle.

### BRIEF DESCRIPTION OF THE DRAWINGS

FIG. 1 is a configuration diagram of a vehicle system including a vehicle control device according to an embodiment.

FIG. 2 is a functional configuration diagram of a first controller and a second controller.

FIG. 3 is a diagram showing an example of corresponding relationships between driving modes, control states of a vehicle, and tasks.

FIG. 4 is a diagram for describing a process of a learner.

FIG. 5 is a diagram for describing processes of a recognizer and a deviation determiner.

FIG. 6 is a diagram for describing runway decision based on a determination result of a deviation determiner.

FIG. 7 is a flowchart showing an example of a flow of a process executed by an automated driving control device.

### DESCRIPTION OF EMBODIMENTS

Hereinafter, embodiments of a vehicle control device, a vehicle control method, and a storage medium of the present invention will be described with reference to the drawings. Hereinafter, an embodiment in which the vehicle control device is applied to an automated driving vehicle will be described as an example. For example, automated driving is a process of executing driving control by automatically controlling one or both of steering and a speed of the vehicle (independent of an operation of a driver). For example, the driving control may include various types of driving control such as a lane keeping assistance system (LKAS), auto lane changing (ALC), adaptive cruise control (ACC), and a collision mitigation brake system (CMBS). The driving control may include driving assistance control for the driver such as an advanced driver assistance system (ADAS). In the automated driving vehicle, the driving may be controlled according to manual driving of the driver.

### [Overall Configuration]

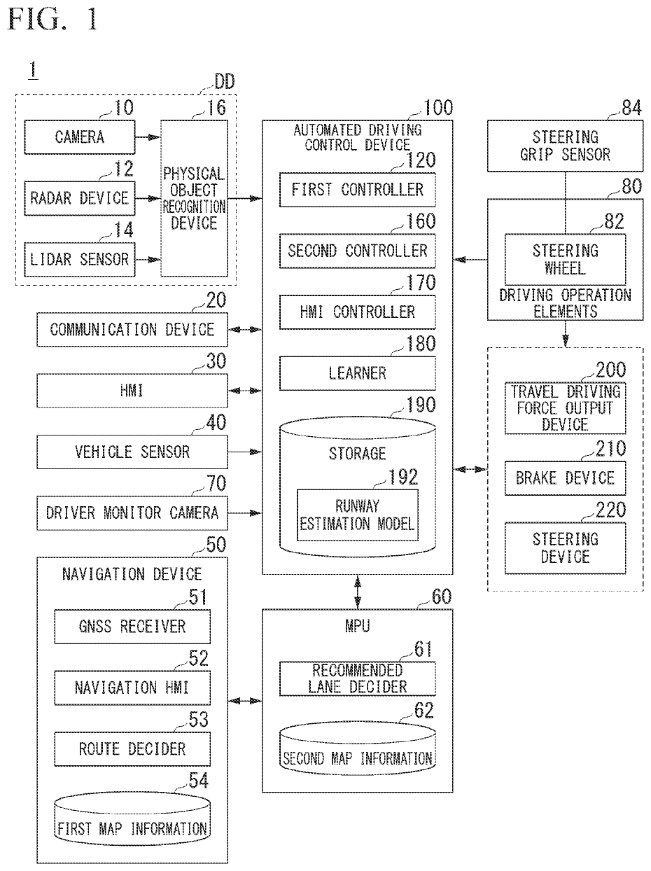

FIG. 1 is a configuration diagram of a vehicle system 1 including the vehicle control device according to the present embodiment. A vehicle (hereinafter referred to as a vehicle M) in which the vehicle system 1 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by a power generator connected to the internal combustion engine or electric power that is supplied when a secondary battery (power storage) or a fuel cell is discharged.

For example, the vehicle system 1 includes a camera 10, a radar device 12, a light detection and ranging (LIDAR) sensor 14, a physical object recognition device 16, a communication device 20, a human machine interface (HMI) 30, a vehicle sensor 40, a navigation device 50, a map positioning unit (MPU) 60, a driver monitor camera 70, driving operation elements 80, an automated driving control device 100, a travel driving force output device 200, a brake device 210, and a steering device 220. Such devices and equipment are connected to each other by a multiplex communication line such as a controller area network (CAN) communication line, a serial communication line, or a wireless communication network. The configuration shown in FIG. 1 is merely an example and some of the components may be omitted or other components may be further added. The automated driving control device 100 is an example of a “vehicle control device.” A combination of the camera 10, the radar device 12, the LIDAR sensor 14, and the physical object recognition device 16 is an example of a “detection device DD.” The HMI 30 is an example of an “output.” The detection device DD detects a surrounding situation of the vehicle M.

For example, the camera 10 is a digital camera using a solid-state imaging element such as a charge-coupled device (CCD) or a complementary metal oxide semiconductor (CMOS). The camera 10 is attached to any location on the vehicle M in which the vehicle system 1 is mounted. For example, when the view in front of the vehicle M is imaged, the camera 10 is attached to an upper part of a front windshield, a rear surface of a rearview mirror, a front part of a vehicle body, or the like. When the view to the rear of the vehicle M is imaged, the camera 10 is attached to an upper part of a rear windshield, a back door, or the like. When the views to the side of the vehicle M are imaged, the camera 10 is attached to a door mirror, or the like. For example, the camera 10 periodically and iteratively images the surroundings of the vehicle M. The camera 10 may be a stereo camera.

The radar device 12 radiates radio waves such as millimeter waves around the vehicle M and detects at least a position (a distance to and a direction) of a physical object by detecting radio waves (reflected waves) reflected by the physical object near the vehicle M. The radar device 12 is attached to any location on the vehicle M. The radar device 12 may detect a position and a speed of the physical object in a frequency-modulated continuous wave (FM-CW) scheme.

The LIDAR sensor 14 radiates light to the vicinity of the vehicle M and measures scattered light. The LIDAR sensor 14 detects a distance from an object on the basis of time from light emission to light reception. The radiated light is, for example, pulsed laser light. The LIDAR sensor 14 is attached to any location on the vehicle M.

The physical object recognition device 16 performs a sensor fusion process on detection results of some or all of the camera 10, the radar device 12, and the LIDAR sensor 14 and recognizes a position, type, speed, and the like of a physical object near the vehicle M. Examples of the physical object include other vehicles (for example, nearby vehicles within a prescribed distance from the vehicle M), pedestrians, bicycles, road structures, and the like. The road structures include, for example, road signs, traffic signals, railroad crossings, curbs, median strips, guardrails, fences, and the like. The road structure may include, for example, road surface signs such as road markings (hereinafter simply referred to as “markings”) drawn on or affixed to the road surface, pedestrian crossings, bicycle crossings, and stop lines. The physical object recognition device 16 outputs a recognition result to the automated driving control device 100. The physical object recognition device 16 may output detection results of the camera 10, the radar device 12, and the LIDAR sensor 14 to the automated driving control device 100 as they are. In this case, the physical object recognition device 16 may be omitted from the configuration of the vehicle system 1 (specifically, the detection device DD). The physical object recognition device 16 may be included in the automated driving control device 100.

The communication device 20 communicates with another vehicle located in the vicinity of the vehicle M, a terminal device of a user using the vehicle M, or various types of server devices using, for example, a cellular network, a Wi-Fi network, Bluetooth (registered trademark), dedicated short-range communication (DSRC), a local area network (LAN), a wide area network (WAN), a network such as the Internet, or the like.

The HMI 30 outputs various types of information to occupants (including the driver) of the vehicle M and receives input operations from the occupants. The HMI 30 includes, for example, various types of display devices, touch panels, switches, keys, speakers, buzzers, microphones, and the like. The HMI 30 may include a light emitter such as an indicator or lamp that can be lighted or flashed in one or more colors. The HMI 30 is provided at a position where the occupant can see, for example, such as the instrument panel or the steering wheel 82.

The vehicle sensor 40 includes a vehicle speed sensor configured to detect the speed of the vehicle M, an acceleration sensor configured to detect acceleration, a yaw rate sensor configured to detect a yaw rate (for example, a rotational angular velocity around a vertical axis passing through the center of gravity of the vehicle M), a direction sensor configured to detect the direction of the vehicle M, and the like. The vehicle sensor 40 may include a position sensor configured to detect the position of the vehicle M. The position sensor is, for example, a sensor configured to acquire position information (longitude/latitude information) from a Global Positioning System (GPS) device. The position sensor may be a sensor configured to acquire position information using the global navigation satellite system (GNSS) receiver 51 of the navigation device 50. A detection result of the vehicle sensor 40 is output to the automated driving control device 100.

For example, the navigation device 50 includes the GNSS receiver 51, a navigation HMI 52, and a route decider 53. The navigation device 50 stores first map information 54 in a storage device such as a hard disk drive (HDD) or a flash memory. The GNSS receiver 51 identifies a position of the vehicle M on the basis of a signal received from a GNSS satellite. The position of the vehicle M may be identified or complemented by an inertial navigation system (INS) using an output of the vehicle sensor 40. The GNSS receiver 51 may be provided in the vehicle sensor 40. The position sensor and the GNSS receiver 51 described above are examples of a “position detector.” The navigation HMI 52 includes a display device, a speaker, a touch panel, a key, and the like. The navigation HMI 52 may be partly or wholly shared with the above-described HMI 30. For example, the route decider 53 decides on a route (hereinafter referred to as a route on a map) from the position of the vehicle M identified by the GNSS receiver 51 (or any input position) to a destination input by the occupant using the navigation HMI 52 with reference to the first map information 54. The first map information 54 is, for example, information in which a road shape is expressed by a link indicating a road of a prescribed segment and nodes connected by the link. The first map information 54 may include point of interest (POI) information, and the like. The route on the map is output to the MPU 60. The navigation device 50 may perform route guidance using the navigation HMI 52 on the basis of the route on the map. The navigation device 50 may transmit a current position and a destination to a navigation server via the communication device 20 and acquire a route equivalent to the route on the map from the navigation server. The navigation device 50 outputs a decided route on the map to the MPU 60.

For example, the MPU 60 includes a recommended lane decider 61 and holds second map information 62 in a storage device such as an HDD or a flash memory. The recommended lane decider 61 divides the route on the map provided from the navigation device 50 into a plurality of blocks (for example, divides the route every 100 [m] in a travel direction of the vehicle), and decides on a recommended lane for each block with reference to the second map information 62. For example, the recommended lane decider 61 decides in what lane numbered from the left the vehicle will travel. The lane is defined by markings. The recommended lane decider 61 decides on the recommended lane so that the vehicle M can travel along a reasonable route for traveling to a branching destination when there is a branch point on the route on the map.

The second map information 62 is more accurate than the first map information 54. The second map information 62 includes, for example, information about a road shape, a road structure, and the like. The road shape includes a more detailed road shape than the first map information 54 such as, for example, branching/merging, a tunnel (entrance or exit), a curve path (entrance or exit), curvature of a road or a marking, a curvature radius, the number of lanes, a width, a gradient, or the like. The above-described information may be stored in the first map information 54. The information about the road structure may include information such as a type of road structure, a position, an orientation in an extension direction of a road, a size, a shape, and a color. In the type of road structure, for example, the marking may be one type, and each of a lane mark, a curb, a median strip, and the like belonging to the markings may be a different type. The type of marking may include, for example, a marking indicating that the lane change is possible and a marking indicating that lane change is not possible. The type of marking, for example, may be set for each segment of the road or lane based on the link and a plurality of types may be set in one link.

The second map information 62 may include location information (latitude and longitude) of roads and buildings, address information (address/postal code), facility information, telephone number information, information of prohibition segments in which mode A or B is prohibited to be described below, and the like. The second map information 62 may be updated at any time by the communication device 20 communicating with the external device. The first map information 54 and the second map information 62 may be integrally provided as map information. Map information (the first map information 54 and the second map information 62) may be stored in the storage 190.

The driver monitor camera 70 is, for example, a digital camera that uses a solid-state image sensor such as a CCD or a CMOS. The driver monitor camera 70 is, for example, attached to any location on the vehicle M with respect to a position and a direction where the head of the driver sitting in the driver's seat of the vehicle M or another occupant sitting in a passenger or rear seat can be imaged from the front (in a direction in which his/her face is imaged). For example, the driver monitor camera 70 is attached to an upper part of a display device provided on the central portion of the instrument panel of the vehicle M, an upper part of a front windshield, a rear mirror, or the like. The driver monitor camera 70, for example, captures an image including the vehicle cabin periodically and repeatedly.

For example, the driving operation elements 80 include an accelerator pedal, a brake pedal, a shift lever, and other operation elements in addition to a steering wheel 82. A sensor configured to detect an amount of operation or the presence or absence of an operation is attached to the driving operation element 80 and a detection result of the sensor is output to the automated driving control device 100 or some or all of the travel driving force output device 200, the brake device 210, and the steering device 220. The steering wheel 82 is an example of an “operation element that receives a steering operation by the driver.” The operation element does not necessarily have to be annular and may be in the form of a variant steering wheel, a joystick, a button, or the like. A steering grip sensor 84 is attached to the steering wheel 82. The steering grip sensor 84 is implemented by a capacitance sensor or the like and outputs a signal for detecting whether or not the driver is gripping the steering wheel 82 (indicating that the driver is in contact with the steering wheel 82 in a state in which a force can be applied) to the automated driving control device 100. In the driving operation element 80, for example, a reaction force device that adjusts an operation amount for steering or a speed according to manual driving of the driver may be provided.

The automated driving control device 100 executes driving control that controls one or both of the steering or speed of the vehicle M on the basis of the surrounding situation of the vehicle M and the like. The automated driving control device 100 includes, for example, a first controller 120, a second controller 160, an HMI controller 170, a learner 180, and a storage 190. Each of the first controller 120, the second controller 160, the HMI controller 170, and the learner 180 is implemented, for example, by a hardware processor such as a central processing unit (CPU) executing a program (software). Also, some or all of the above components may be implemented by hardware (including a circuit: circuitry) such as a large-scale integration (LSI) circuit, an application-specific integrated circuit (ASIC), a field-programmable gate array (FPGA), or a graphics processing unit (GPU) or may be implemented by software and hardware in cooperation. The program may be pre-stored in a storage device (a storage device including a non-transitory storage medium) such as an HDD or a flash memory of the automated driving control device 100 or may be stored in a removable storage medium such as a DVD, a CD-ROM, or a memory card and installed in the storage device of the automated driving control device 100 when the storage medium (the non-transitory storage medium) is mounted in a drive device, a card slot, or the like. The HMI controller 170 is an example of a “notification controller.”

The storage 190 may be implemented by the above-described various storage devices an electrically erasable programmable read-only memory (EEPROM), a read-only memory (ROM), a random-access memory (RAM), or the like. The storage 190 stores, for example, a runway estimation model 192, programs, various other types of information, and the like. The runway estimation model 192 is, for example, a learned model learned by the learner 180 to estimate the runway of the vehicle M. The storage 190 may store map information (the first map information 54 and the second map information 62).

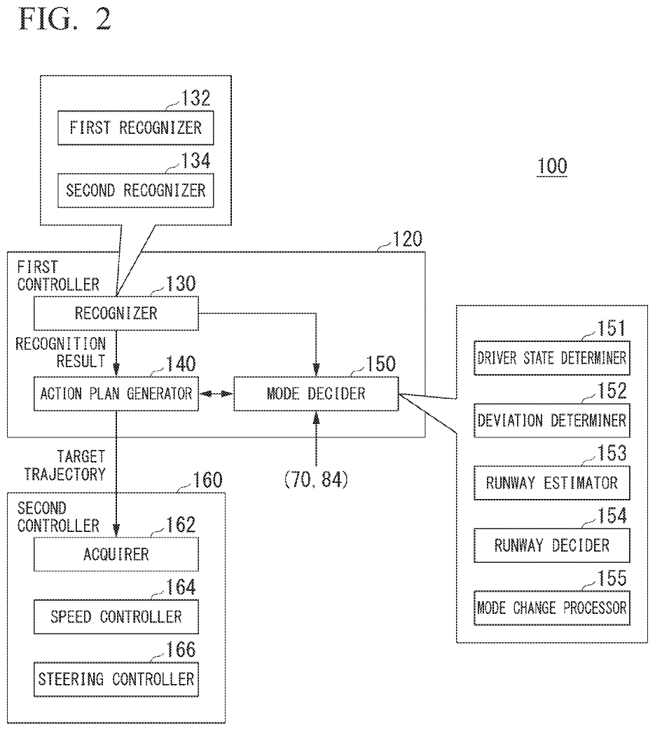

FIG. 2 is a functional configuration diagram of the first controller 120 and the second controller 160. The first controller 120 includes, for example, a recognizer 130, an action plan generator 140, and a mode decider 150. The first controller 120 implements, for example, a function of artificial intelligence (AI) and a function of a predetermined model in parallel. For example, an “intersection recognition” function may be implemented by executing intersection recognition based on deep learning or the like and recognition based on previously given conditions (signals, road signs, or the like, with which pattern matching is possible) in parallel and performing comprehensive evaluation by assigning scores to both recognitions. Thereby, the reliability of automated driving is secured. The first controller 120 executes control relating to automated driving of the vehicle M on the basis of, for example, instructions from the MPU 60, the HMI controller 170, or the like. An example of a “travel controller” is a combination of the recognizer 130, the action plan generator 140, and the second controller 160. The travel controller controls the traveling of the vehicle M in a runway (an available travel region) decided on according to, for example, first information based on the output of the detection device that detects the surrounding situation of the vehicle M and second information based on the map information.

The recognizer 130 recognizes a surrounding situation of the vehicle M on the basis of a recognition result of the detection device DD (information input from the camera 10, the radar device 12, and the LIDAR sensor 14 via the physical object recognition device 16). For example, the recognizer 130 recognizes states of the type, position, speed, and acceleration of the vehicle M and physical objects located near the vehicle M. The type of the physical object may be, for example, a type such as whether the physical object is a vehicle or a pedestrian, or may be a type for identifying each vehicle. The position of the physical object, for example, is recognized as a position of an absolute coordinate system (hereinafter referred to as a vehicle coordinate system) having a representative point of the vehicle M (a center of gravity, a drive shaft center, or the like) as the origin, and is used for control. The position of the physical object may be represented by a representative point such as the center of gravity or a corner of the physical object or a tip portion in the travel direction or may be represented in the expressed region. The speeds include, for example, speeds of the vehicle M and other vehicles (hereinafter referred to as longitudinal speeds) in the travel direction (longitudinal direction) of the travel lane and speeds of the vehicle M and other vehicles (hereinafter referred to as lateral speeds) in the lateral direction of the lane. The “state” of the physical object may include, for example, the acceleration or jerk of the physical object, or the “action state” (for example, whether or not the lane is changing or is about to change) when the physical object is a mobile object such as another vehicle.

The recognizer 130 includes, for example, a first recognizer 132 and a second recognizer 134. The first recognizer 132 recognizes the first information about the runway of the vehicle M on the basis of the output of the detection device DD that detects the surrounding situation of the vehicle M. The second recognizer 134 recognizes the second information about the runway of the vehicle M on the basis of the position information of the vehicle M and the map information. The first information and the second information include, for example, information about the travel lane of the vehicle M (for example, a shape, type, width, and the like) and marking information for defining the travel lane. The first information and the second information may include lanes around the vehicle M (including lanes located in a travel direction (for example, a forward direction)) and the marking information thereof. The first information and the second information may include information of an available travel region within a lane such as the right or left side of the lane.

The action plan generator 140 generates an action plan for causing the vehicle M to travel according to driving control of automated driving or the like on the basis of a recognition result of the recognizer 130, a driving mode decided on by the mode decider 150, or the like. For example, the action plan generator 140 generates a future target trajectory along which the vehicle M will automatically travel (independently of the driver's operation) so that the vehicle M can generally travel in the recommended lane decided on by the recommended lane decider 61 and further cope with a surrounding situation of the vehicle M on the basis of a nearby road shape, a marking recognition result, or the like based on the recognition result of the recognizer 130 or a current position of the vehicle M acquired from map information. For example, the target trajectory includes a speed element. For example, the target trajectory is represented by sequentially arranging points (trajectory points) at which the vehicle M is required to arrive. The trajectory points are points at which the vehicle M is required to arrive for each prescribed traveling distance (for example, about several meters [m]) along a road. In addition, a target speed (and target acceleration) for each prescribed sampling time (for example, about 0.x [sec] where x is a decimal number) is generated as a part of the target trajectory. Also, the trajectory point may be a position where the vehicle M is required to arrive at the sampling time for each prescribed sampling time. In this case, information of the target speed (and the target acceleration) is represented by an interval between the trajectory points.

The action plan generator 140 may set an automated driving event in generating the target trajectory. Examples of the event include a constant speed driving event in which the vehicle M travels in the same lane at a constant speed, a tracking driving event for causing the vehicle M to track another vehicle (hereinafter referred to as a preceding vehicle) located within a predetermined distance (for example, within 100 [m]) in front of the vehicle M and closest to the vehicle M, a lane change event for causing the vehicle M to change lanes from a host vehicle lane to an adjacent lane, a branching-point-related movement event for causing the vehicle M to move to a lane in a destination direction at a branching point of a road, a merging-point-related movement event for causing the vehicle M to move to a lane of a main road at a merging point, a takeover event for ending automated driving and performing switching to manual driving, and the like. The action plan generator 140 generates a target trajectory corresponding to the activated event.

The mode decider 150 decides on the driving mode of the vehicle M as any of a plurality of driving modes in which the tasks imposed on the driver (an example of an occupant) are different. The mode decider 150 includes, for example, a driver state determiner 151, a deviation determiner 152, a runway estimator 153, a runway decider 154, and a mode change processor 155.

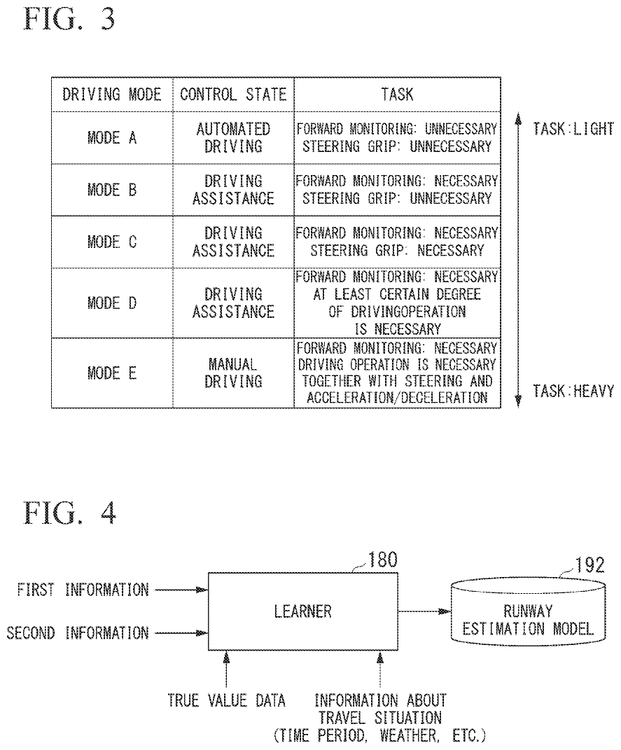

FIG. 3 is a diagram showing an example of corresponding relationships between the driving modes, the control states of the vehicle M, and the tasks. For example, there are five modes from mode A to mode E as the driving modes of the vehicle M. In the five modes described above, a control state, i.e., a degree of automation of the driving control of the vehicle M, is highest in mode A, lower in the order of mode B, mode C, and mode D, and lowest in mode E. In contrast, a task imposed on the driver is lightest in mode A, heavier in the order of mode B, mode C, and mode D, and heaviest in mode E. Because of a control state that is not automated driving in modes D and E, the automated driving control device 100 is responsible for ending control relating to automated driving and shifting the driving mode to driving assistance or manual driving. The content of the driving modes will be exemplified below.

In mode A, in an automated driving state, neither surroundings monitoring of the vehicle M nor gripping of the steering wheel 82 (hereinafter referred to as a steering grip) is imposed on the driver. The surroundings monitoring includes at least monitoring the front of vehicle M. However, in mode A as well, the driver is required to be in a posture in which driving can be quickly shifted to manual driving in response to a request from a system centering on the automated driving control device 100. The term “automated driving” as used herein indicates that both steering and a speed of the vehicle M are controlled independently of the operation of the driver. The front indicates a space in a travel direction of the vehicle M visually recognized via the front windshield. Mode A is, for example, a driving mode in which the vehicle M travels at a prescribed speed (for example, about 50 [km/h]) or lower on a motorway such as an expressway and which can be executed when a condition in which there is a preceding vehicle, which is the tracking target, or the like is satisfied. Mode A may be referred to as a traffic jam pilot (TJP). When this condition is no longer satisfied, the mode decider 150 changes the driving mode of the vehicle M to mode B.

In mode B, in a driving assistance state, a task of monitoring a forward direction of the vehicle M (hereinafter referred to as forward monitoring) is imposed on the driver, but a task of gripping the steering wheel 82 is not imposed on the driver. In mode C, in a driving assistance state, a forward monitoring task and a task of gripping the steering wheel 82 are imposed on the driver. Mode D is a mode in which a certain degree of driving operation is required for at least one of steering and acceleration/deceleration of the vehicle M is imposed on the driver. For example, in mode D, driving assistance such as adaptive cruise control (ACC) or a lane keeping assist system (LKAS) is performed. In mode E, manual driving in which a task requiring a driving operation for both steering and acceleration/deceleration is imposed on the driver is performed. In both modes D and E, a task of monitoring a forward direction of the vehicle M is naturally imposed on the driver. In the embodiment, for example, when mode A is a “first driving mode,” modes B to E are examples of a “second driving mode.” When mode B is the “first driving mode,” modes C to E are examples of the “second driving mode.” That is, the task imposed on the driver in the second driving mode is heavier than that in the first driving mode.

The driving mode is not limited to that illustrated in FIG. 3 and may be defined by other definitions. For example, in the driving modes required for both forward monitoring and steering gripping, there may be a loose or severe threshold value for determining that the steering wheel is gripped. More specifically, it is only necessary for the driver's left or right hand to touch the steering wheel 82 in a certain driving mode, but in another driving mode where the task imposed on the driver is heavier, the driving mode may be defined so that the driver needs to grip the steering wheel 82 with both hands at a strength of the threshold value or more. In addition, driving modes in which the severity of the task imposed on the driver is different may be defined in any way.

The driving assistance degree (in other words, the automated driving control degree) for the driver of the vehicle M may differ depending on the difference in the driving mode. For example, the driving assistance degree (the automated driving control degree) for the driver in the case of the second driving mode is lower than that in the case of the first driving mode. Even in the second driving mode, the driving assistance degree may be reduced as the mode in which the task assigned to the driver becomes heavy when the mode is different. Reducing the driving assistance degree includes, for example, reducing the maximum assistance amount of steering (for example, a maximum torque). Reducing the driving assistance degree may include reducing a speed range (for example, an upper speed limit) that can be supported in speed assistance instead of (or in addition to) the above-described content.

The driver state determiner 151 determines whether or not an occupant (driver) is in a state suitable for driving. For example, the driver state determiner 151 monitors the state of the occupant for the above-described mode change and determines whether or not the state of the occupant is a state corresponding to the task. For example, the driver state determiner 151 performs a posture estimation process by analyzing an image captured by the driver monitor camera 70 and determines whether or not the occupant is in a posture in which the driving cannot be shifted to the manual driving in response to a request from the system. The driver state determiner 151 performs a visual line estimation process by analyzing the image captured by the driver monitor camera 70 and determines whether or not the occupant is monitoring the surroundings (more specifically, the forward direction) of the vehicle M. When it is determined that the state is not corresponding to the task for a prescribed period of time or more, the driver state determiner 151 determines that the occupant is not suitable for driving of the task or that the task relating to the driving mode is not executed by the driver. When it is determined that the state is corresponding to the task, the driver state determiner 151 determines that the occupant is in a state suitable for driving of the task or a state in which the task relating to the driving mode is executed by the driver. The driver state determiner 151 may determine whether or not the occupant is in a state where driving changes are possible.

The deviation determiner 152 determines whether or not there is a deviation between the first information recognized by the first recognizer 132 and the second information recognized by the second recognizer (or whether or not there is a difference therebetween). The deviation determiner 152 may acquire the deviation degree between the first information and the second information.

When the deviation determiner 152 determines that there is a deviation between the first information and the second information, the runway estimator 153 estimates the runway of the vehicle M on the basis of the first information and the second information and outputs an estimation result (runway estimation information) to the runway decider 154. The estimation result includes information indicating a lane where the vehicle M is estimated to be traveling between a lane included in the first information and a lane included in the second information. The estimation result may include information about an available travel region in the lane such as the right or left side of the lane. The estimation result may include priority information indicating which of the first information and the second information takes priority. Priority information may be, for example, information about priority, and may be information indicating a priority degree for information (for example, a priority degree of 0.7 for the first information, a priority degree of 0.3 for the second information, or the like).

The runway decider 154 determines a runway (an available travel region) where the vehicle M travels on the basis of the first information and the second information. For example, the runway decider 154 decides on a runway using one or more predetermined information items of the first information and the second information when the deviation determiner 152 determines that there is no deviation between the first information and the second information and decides on a runway on the basis of the first information, the second information, and the estimation result of the runway estimator 153 when it is determined that there is a deviation therebetween. Details of the processes of the deviation determiner 152, the runway estimator 153, and the runway decider 154 will be described below.

The mode change processor 155 decides on or changes the driving mode executed by the vehicle M on the basis of a determination result of the driver state determiner 151, a determination result of the deviation determiner 152, and the like. For example, the mode change processor 155 changes the driving mode of the vehicle M to a driving mode with a heavier task when the task relating to the decided driving mode is not executed by the driver. For example, in mode A, when the driver is in a posture where he/she cannot shift the driving to manual driving in response to a request from the system (for example, when he/she continues to look outside an allowable area or when a sign that driving is difficult is detected), the mode change processor 155 performs a control process of prompting the driver to shift the driving to manual driving using the HMI 30, causing the vehicle M to gradually stop close to the road shoulder when the driver does not respond, and stopping the automated driving. After the automated driving is stopped, the vehicle M is in a state of mode D or E. Thereby, the vehicle M can be started according to the manual driving of the driver. Hereinafter, the same is true for “stopping the automated driving.” When the driver is not performing forward monitoring in mode B, the mode change processor 155 performs a control process of prompting the driver to perform the forward monitoring using the HMI 30, causing the vehicle M to gradually stop close to the road shoulder when the driver does not respond, and stopping the automated driving. When the driver is not performing the forward monitoring or is not gripping the steering wheel 82 in mode C, the mode change processor 155 performs a control process of prompting the driver to perform the forward monitoring and/or grip the steering wheel 82 using the HMI 30, causing the vehicle M to gradually stop close to the road shoulder when the driver does not respond, and stopping the automated driving. Changes in the driving mode based on the determination result of the deviation determiner 152 and the like will be described below.

The second controller 160 controls the travel driving force output device 200, the brake device 210, and the steering device 220 so that the vehicle M passes along the target trajectory generated by the action plan generator 140 at the scheduled times. The second controller 160 includes, for example, an acquirer 162, a speed controller 164, and a steering controller 166. The acquirer 162 acquires information of a target trajectory (trajectory points) generated by the action plan generator 140 and causes a memory (not shown) to store the information. The speed controller 164 controls the travel driving force output device 200 or the brake device 210 on the basis of a speed element associated with the target trajectory stored in the memory. The steering controller 166 controls the steering device 220 in accordance with a degree of curvature of the target trajectory stored in the memory. The processes of the speed controller 164 and the steering controller 166 are implemented by, for example, a combination of feedforward control and feedback control. As an example, the steering controller 166 executes feedforward control according to a curvature radius (or curvature) of the road in front of the vehicle M and feedback control based on a deviation from the target trajectory in combination.

The HMI controller 170 notifies the occupant of prescribed information through the HMI 30. The prescribed information includes, for example, information about traveling of the vehicle M such as information about the state of the vehicle M and information about driving control. The information about the state of the vehicle M includes, for example, a speed, an engine speed, a shift position, and the like of the vehicle M. Information about driving control includes control content in the travel controller, for example, whether or not driving control by automated driving is executed, information for inquiring about whether or not to start automated driving, a situation of driving control by automated driving (for example, driving mode or event content in progress), information about a driving assistance degree, information about the switching of the driving mode, and the like. The prescribed information may include, for example, information about the current position and destination of the vehicle M, and the remaining amount of fuel. The prescribed information may include information irrelevant to travel control of the vehicle M, such as content (for example, movies) stored in a storage medium such as a TV program or a DVD.

For example, the HMI controller 170 may generate an image including the prescribed information described above, cause the display device of the HMI 30 to display the generated image, generate a sound indicating the prescribed information, and cause the generated sound to be output from a speaker of the HMI 30. The HMI controller 170 may cause light emitters such as indicators and lamps included in the HMI 30 to be turned on or flashed in a prescribed color. The HMI controller 170 may cause information received by the HMI 30 to be output to the communication device 20, the navigation device 50, the first controller 120, or the like. The HMI controller 170 may transmit various types of information output to the HMI 30 to a terminal device used by the occupants of the vehicle M via the communication device 20. The terminal device is, for example, a smartphone or a tablet terminal.

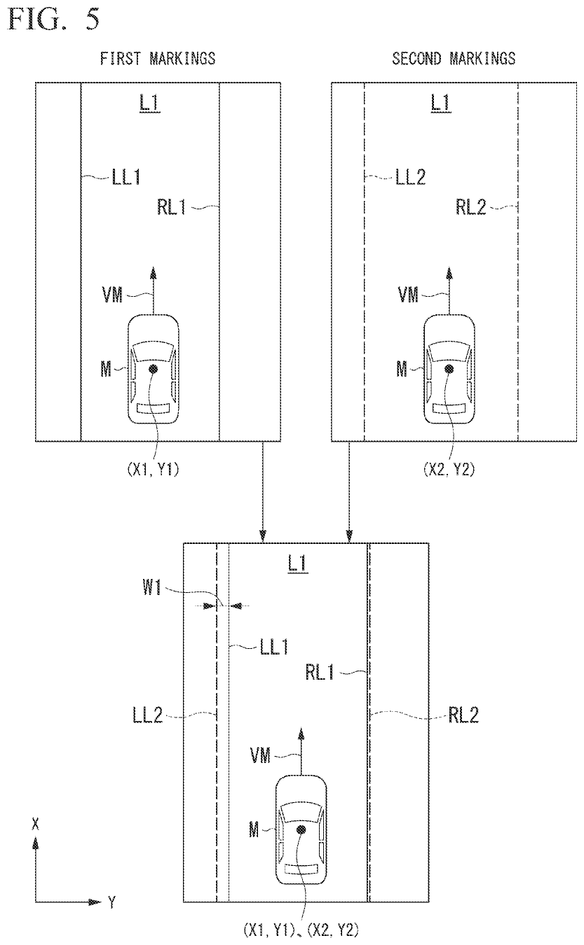

The learner 180 generates a runway estimation model 192 in which the first information recognized by the first recognizer 132 and the second information recognized by the second recognizer 134 are input and the estimation result of the travel lane of the vehicle M is output. FIG. 4 is a diagram for describing a process of the learner 180. For example, the learner 180 generates the runway estimation model 192 in which the first information and the second information are input and a result of estimating the runway of the vehicle M is output according to a function based on artificial intelligence (AI) such as machine learning (a neural network) or deep learning using the first information and the second information provided in advance and true value (correct answer) data. The true value data is, for example, information about the runway on which the vehicle has actually traveled at a point in time when the first information and the second information have been recognized.

In addition to the first information and the second information, the learner 180 includes information about a travel situation when the first information and the second information are recognized, so that the runway estimation model 192 in which the first information, the second information, and the information about the travel situation may be input and the runway estimation result is output may be generated. The travel situation is, for example, information of a time period when the vehicle traveled, weather, and the like. The time period may include classifications of the day and night, information about the month, day, and period, information of the season, and the like. The travel situation may include a traffic jam situation or the like. In particular, it is possible to generate the runway estimation model 192 having higher accuracy by learning the first information recognized using the output of the detection device DD together with information about a travel situation because a recognition result may differ with a travel situation at the time of detection or the runway may change due to an influence of road construction (for example, night construction or end-of-year construction), traffic congestion, or the like. The learner 180 may generate the runway estimation model 192 in which the first information, the second information, and information about the vehicle model (and the travel situation) are input and the runway estimation result is output by including vehicle model information in addition to (or in place of) information about the travel situation. Because an installation position of the detection device DD, the number of detection devices DD, recognition performance, or the like differs for each vehicle model, and a recognition result accompanying it is also different, a more accurate runway estimation model 192 can be generated by performing learning including information about a vehicle model.

The learner 180 may update the runway estimation model 192 on the basis of the runway estimated by the runway estimator 153 (or the runway decided on by the runway decider 154) and the runway where the driver actually traveled according to manual driving (mode E) or the like. For example, when the runway estimated by the runway estimator 153 using the runway estimation model 192 is a runway based on the first information and the runway where the driver actually traveled in the manual driving is a runway based on the second information, because the runway is different, the learner 180 performs relearning on the basis of the first information, the second information, and the information of the actual running runway, and updates the runway estimation model. The relearning may be executed when the deviation degree between the first information and the second information is greater than or equal to a threshold value or when the runway estimated by the runway estimator 153 is different from the runway where the vehicle M actually traveled according to a manual driving operation of the driver. By performing the relearning, a more accurate runway estimation model 192 can be generated. The runway estimation model 192 may be generated or updated by the learner 180 or acquired from an external device via a network.

The travel driving force output device 200 outputs a travel driving force (torque) for enabling the traveling of the vehicle M to driving wheels. For example, the travel driving force output device 200 includes a combination of an internal combustion engine, an electric motor, a transmission, and the like, and an electronic control unit (ECU) that controls the internal combustion engine, the electric motor, the transmission, and the like. The ECU controls the above-described components in accordance with information input from the second controller 160 or information input from the accelerator pedal of the driving operation element 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the second controller 160 or the information input from the accelerator pedal of the driving operation element 80 so that brake torque according to a braking operation is output to each wheel. The brake device 210 may include a mechanism configured to transfer the hydraulic pressure generated according to an operation on the brake pedal to the cylinder via a master cylinder as a backup. The brake device 210 is not limited to the above-described configuration and may be an electronically controlled hydraulic brake device configured to control an actuator in accordance with information input from the second controller 160 and transfer the hydraulic pressure of the master cylinder to the cylinder.

For example, the steering device 220 includes a steering ECU and an electric motor. For example, the electric motor changes a direction of steerable wheels by applying a force to a rack and pinion mechanism. The steering ECU drives the electric motor in accordance with the information input from the second controller 160 or the information input from the driving operation element 80 to change the direction of the steerable wheels.

### [Recognizer and Mode Decider]

Hereinafter, details of each function included in the recognizer 130 and the mode decider 150 (other than the function of the driver state determiner 151) will be described. In the following example, the first information recognized by the first recognizer 132 and the second information recognized by the second recognizer 134 will be described as marking information.

FIG. 5 is a diagram for describing processes of the recognizer 130 and the deviation determiner 152. In the example of FIG. 5, it is assumed that the vehicle M is traveling in an extension direction of a lane L1 (the X-axis direction in FIG. 5) at a speed VM. In FIG. 5, first markings LL1 and RL1 recognized by the first recognizer 132 in the plane (XY plane) of the vehicle coordinate system and second markings LL2 and RL2 of the same coordinate system recognized by the second recognizer 134 are shown. A position (X1, Y1) shown in FIG. 5 indicates a representative point of the vehicle M when the first marking is recognized by the first recognizer 132 and a position (X2, Y2) indicates a representative point of the vehicle M detected by the position detector when the second marking is recognized by the second recognizer 134.

The first recognizer 132, for example, recognizes the left and right markings LL1 and RL1 for defining the travel lane of the vehicle M on the basis of the output of the detection device DD. The markings LL1 and RL1 are examples of the “first markings.” For example, the first recognizer 132 analyzes an image captured by the camera 10, extracts edge points having a large luminance difference from adjacent pixels in the image, and recognizes the markings LL1 and RL1 in the image plane by connecting the edge points. The first recognizer 132 converts the positions of the markings LL1 and RL1 based on the position (X1, Y1) of the representative point (for example, a center of gravity or center) of the vehicle M into those of a vehicle coordinate system. The first recognizer 132, for example, may recognize the radii or curvature of the first markings LL1 and RL1.

The second recognizer 134, for example, recognizes the markings LL2 and RL2 for defining the travel lane of the vehicle M from the map information on the basis of the position of the vehicle M detected by the position detector. The markings LL2 and RL2 are examples of the “second markings.” For example, the second recognizer 134 acquires the position information of the vehicle M detected by the position detector and recognizes the markings LL2 and RL2 for defining the lane located at the position of the vehicle M from the second map information 62 with reference to the second map information 62 on the basis of the acquired position information (a position (X2, Y2)). The second recognizer 134 recognizes the radii or curvature of the markings LL2 and RL2 from the second map information 62.

The deviation determiner 152 acquires the deviation degree (between the markings LL1 and LL2 and the markings RL1 and RL2) of the left and right by superimposing the position (X1, Y1) and the position (X2, Y2) in the plane (XY plane) of the vehicle coordinate system and performing superimposition so that the direction of the vehicle M is the same. The deviation may be, for example, a deviation in a lateral position (the Y-axis direction in FIG. 5) (for example, a lateral deviation amount W1 between the markings LL1 and LL2 in FIG. 5), a difference in a longitudinal position (a long or short distance in the X-axis direction in FIG. 5), or a combination thereof. The deviation may be an angle (deviation angle) formed by the markings LL1 and LL2 or an angle formed by the markings RL1 and RL2 in place of (or in addition to) the above-described content. The deviation determiner 152 increases the deviation degree as the lateral deviation amount W1 or the deviation angle increases.

When the deviation degree between the markings LL1 and LL2 and the markings RL1 and RL2 is less than the threshold value, the deviation determiner 152 determines that there is no deviation between the first marking and the second marking (or that they match) and determines that the deviation degree is greater than or equal to the threshold value (or that they do not match). The deviation determiner 152 may determine that the first marking and the second marking do not match when the deviation degree greater than or equal to the threshold value continues for a predetermined period of time or more. Thereby, because it is possible to suppress the frequent switching of the result of determining the deviation degree, the driving control based on the determination result can be further stabilized.

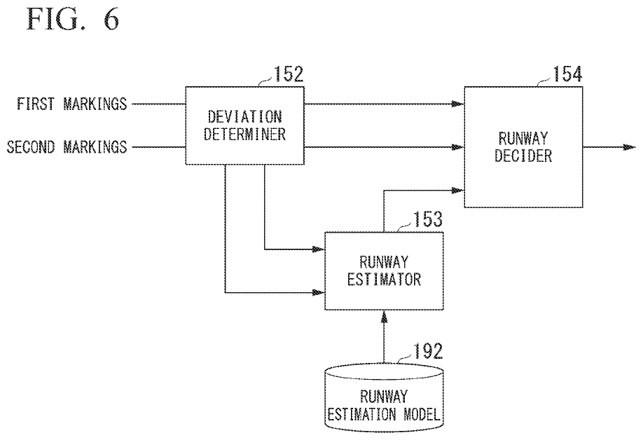

FIG. 6 is a diagram for describing runway decision based on the determination result of the deviation determiner 152. When it is determined that the first marking and the second marking are different, the deviation determiner 152 outputs information about the first marking and the second marking to the runway estimator 153 and the runway decider 154. The runway estimator 153 acquires a result of estimating the runway of the vehicle M for the input of the first marking and the second marking using the runway estimation model 192 and outputs an estimation result to the runway decider 154.

The runway estimator 153 may acquire information about the travel situation (such as the current time and information of weather around the vehicle M) from an external device connected via the vehicle M or the communication device 20 and also acquire an estimation result by inputting the acquired information to the runway estimation model 192. In addition to (or in place of) information about the travel state, the runway estimator 153 may also acquire an estimation result by inputting vehicle model information of the vehicle M to the runway estimation model 192. Thereby, it is possible to acquire an estimation result corresponding to a difference in recognition performance or the like based on a driving situation or the vehicle model.

The runway decider 154 decides on the runway of the vehicle M from information of the first markings and the second markings. For example, when the deviation degree between the first marking and the second marking is less than a threshold value (or when they match), the runway decider 154 decides on the runway (an available runway region) where the vehicle M travels using one or both of the first marking and the second marking. Using both markings involves, for example, using both markings that are superimposed, or using one marking while using at least a part of the other marking interpolatively.

When the deviation degree between the first marking and the second marking is greater than or equal to the threshold value (or when they do not match), the runway decider 154 decides on the runway of the vehicle M on the basis of the first marking, the second marking, and the estimated result (for example, priority information) of the runway estimator 153. For example, the runway decider 154 decides on the lane defined by the first marking as the runway when the first marking has higher priority than the second marking in the estimation result. For example, when the first information indicates an available travel region on the right side of the lane, the second information indicates an available travel region on the left side of the same lane, and the first information has higher priority than the second information in the estimated result, the runway decider 154 decides on the right side of the lane as the runway. The runway decider 154 may decide on the final runway by adjusting the position of the runway in accordance with priority degrees of the first information and the second information. Thus, when there is a deviation between the first marking and the second marking, the accuracy of the runway decision can be further improved by performing the runway estimation using the runway estimation model 192.

For example, when automated driving or driving assistance is executed on the basis of the execution driving mode, the action plan generator 140 generates a target trajectory for the vehicle M to travel in the center of the runway decided on by the runway decider 154 and outputs the generated target trajectory to the second controller 160 to execute driving control.

The mode change processor 155 changes the driving mode on the basis of, for example, a determination result of the deviation determiner 152. For example, when both the left and right markings of the first markings and the second markings match (the deviation degree is less than a threshold value) and another condition in which the first driving mode is executable is satisfied, the mode change processor 155 changes the mode from the second driving mode to the first driving mode, makes a change to a mode in which a task imposed on the driver is light during the second driving mode, or causes the first driving mode being executed to continue. In a state in which the first driving mode is being executed, the mode change processor 155 executes a process of switching the driving mode from the first driving mode to the second driving mode (for example, modes C to E) when the deviation degree to at least one of the left and right of the first markings and the second markings is greater than or equal to a threshold value. The mode change processor 155 may suppress switching from the first driving mode to the second driving mode until the state in which the deviation degree is greater than or equal to the threshold value continues for a prescribed period of time or more. Thereby, the change in the driving mode when the deviation degree is temporarily greater than or equal to the threshold value is suppressed, and more stable driving control can be implemented. The mode change processor 155 may switch each of the plurality of modes included in the second driving mode stepwise to a mode in which the task imposed on the occupant becomes heavier in accordance with the duration of the state in which the deviation degree is greater than or equal to the threshold value. In this case, the mode is switched to a mode in which a heavier task is imposed when the duration is longer.

When the mode is switched from the first driving mode to the second driving mode due to a deviation between the first marking and the second marking, the HMI controller 170 may cause the HMI 30 to output information indicating the reason for switching in addition to switching of the driving mode. The HMI controller 170 may cause the HMI 30 to output information about a task imposed on the occupant for switching the driving mode (for example, the forward monitoring or gripping of the steering wheel 82). The HMI controller 170 may cause the HMI 30 to output information about an assistance state corresponding to a driving assistance degree when a driving assistance degree for the driver of the vehicle M is changed by switching the driving mode from the first driving mode to the second driving mode according to the deviation between the first marking and the second marking. The HMI controller 170 may change a light emitting mode (a display mode) of a light emitter such as an indicator or lamp included in the HMI 30 in accordance with a change in the driving mode or a change in the assistance state. The light emitting mode is, for example, a mode of lighting, flashing, a flashing cycle, a light emission color, or the like. Thereby, the driver can clearly ascertain a change in the driving assistance state.

### Modified Example

In the above-described embodiment, the learner 180 may learn the runway estimation model 192 with a server (an external device) capable of communicating with the communication device 20. In this case, the learner 180 transmits information of a recognition result or a travel history of the first recognizer 132 or the second recognizer 134, a travel situation or a vehicle model of the vehicle M to the server via the communication device 20. The server receives the information transmitted from the vehicle M, receives similar information from other vehicles, generates the runway estimation model 192 using the received information, and delivers the generated runway estimation model 192 to each vehicle. Thereby, because a runway estimation model can be generated using more information, more accurate runway estimation can be implemented. By executing the learning process on the server, the processing load of the vehicle M can be reduced.

In the embodiment, the deviation determiner 152 may output the first information and the second information to the runway estimator 153 even if the deviation degree between the first information and the second information is less than a threshold value (or even if they match) and cause a runway estimation process to be executed. In this case, the runway decider 154 decides on the runway on the basis of the first information, the second information, and the estimated result obtained from the runway estimator 153, regardless of the deviation degree between the first information and the second information. The runway decider 154 may switch between whether or not to refer to the estimation result when the deviation degree between the first information and the second information is less than the threshold value (or when they match) in accordance with instruction content from the driver input from the HMI 30. Thereby, the runway decision process suitable for the driver's intention can be performed.

### [Processing Flow]

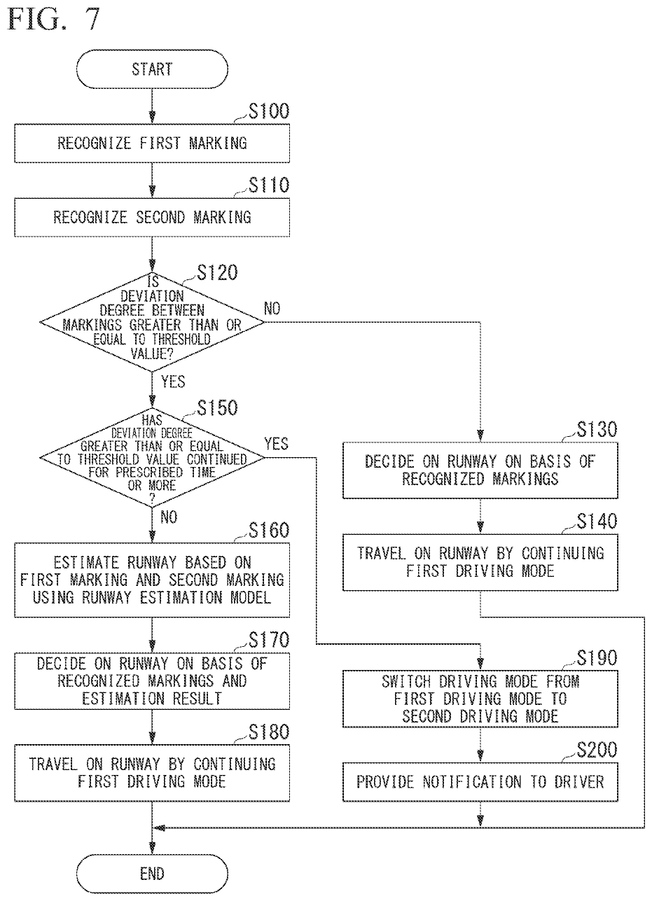

Next, a flow of a process executed by the automated driving control device 100 according to the embodiment will be described. FIG. 7 is a flowchart showing an example of the flow of the process executed by the automated driving control device 100. Hereinafter, a process of deciding on the runway or switching the driving mode of the vehicle M on the basis of a deviation degree between the markings recognized by the first recognizer 132 and the second recognizer 134 in the process executed by the automated driving control device 100 will be mainly described. At the start of the process shown in FIG. 7, it is assumed that the runway estimation model 192 has already been generated. It is assumed that the vehicle M executes driving control based on the first driving mode (for example, mode A). In the following process, in the determination result of the driver state determiner 151, it is assumed that the driver's state is a state suitable for the mode in execution or the mode after switching (i.e., a situation in which the mode switching does not occur on the basis of the determination result of the driver state determiner 151). The process shown in FIG. 7 may be iteratively executed at a prescribed timing.

In the example of FIG. 7, the first recognizer 132 recognizes a first marking for defining a travel lane of the vehicle M on the basis of the output of the detection device DD (step S100). Subsequently, the second recognizer 134 refers to map information on the basis of the position information of the vehicle M obtained from the position detector and recognizes a second marking for defining the travel lane of the vehicle M (step S110). The processing of steps S100 and S110 may be performed in reverse order or in parallel.

Subsequently, the deviation determiner 152 compares the first marking and the second marking to determine whether or not the deviation degree between the markings is greater than or equal to a threshold value (step S120). When it is determined that the deviation degree is not greater than or equal to the threshold value, the runway decider 154 decides on the runway of the vehicle M using one or both of the recognized first and second markings (step S130). Subsequently, the travel controller executes runway control for traveling on the decided runway by continuing the first driving mode (step S140).

In the processing of step S120, when it is determined that the deviation degree between the first marking and the second marking is greater than or equal to the threshold value, the deviation determiner 152 determines whether or not the deviation degree greater than or equal to the threshold value has continued for a prescribed period of time or more (step S150). When it is determined that the deviation degree greater than or equal to the threshold value has not continued for a prescribed period of time or more, the runway estimator 153 estimates the runway of the vehicle M based on the first marking and the second marking using the runway estimation model (step S160). Subsequently, the runway decider 154 determines the runway of the vehicle M on the basis of the recognized markings and the estimation result (step S170). Subsequently, the travel controller executes driving control for traveling on the decided runway by continuing the first driving mode (step S180).

When it is determined that the deviation degree greater than or equal to the threshold value has continued for a prescribed period of time or more in the processing of step S150, the travel controller executes driving control for switching the driving mode from the first driving mode to the second driving mode (step S190). Subsequently, the HMI controller 170 outputs information about the state of vehicle control (driving assistance) to the HMI 30 and notifies the driver of the state (step S200). Thereby, the process of the present flowchart ends.

According to the above-described embodiment, a vehicle control device includes a travel controller configured to control traveling of a vehicle M on a runway decided on according to first information based on an output of a detection device DD obtained by detecting a surrounding situation of the vehicle and second information based on map information; the runway estimator 153 configured to estimate the runway of the vehicle M on the basis of the first information and the second information: and the runway decider 154 configured to decide on the runway of the vehicle M on the basis of the first information, the second information, and runway estimation information about the runway of the vehicle M estimated by the runway estimator 153, thereby improving accuracy of the runway decision of the vehicle.

According to the embodiment, it is possible to more reliably decide on a runway with high safety by estimating the runway using a pre-learned model when the runway of the vehicle M is decided on based on information of markings based on the output of the detection device DD and information of markings acquired from the map information and deciding on the final runway of the vehicle M on the basis of the estimated runway. By deciding on the runway using the runway estimation result using the pre-learned runway estimation model, it is possible to implement the runway decision corresponding to a change in the travel situation or the like instead of making the decision based on a simple predetermined rule. According to the embodiment, the runway including not only the range of the vehicle position but also the travel direction (for example, the forward direction) of the vehicle M can be accurately decided on. In particular, in the field of automated driving, because a target trajectory corresponding to a future runway where the vehicle M will travel is generated and driving control is executed along the target trajectory, more appropriate driving control can be implemented by improving the accuracy of the runway decision (runway selection). Thus, the embodiment can contribute to the development of a sustainable transport system.

The embodiment described above can be represented as follows.

A vehicle control device including:
a storage medium storing computer-readable instructions: and
a processor connected to the storage medium, the processor executing the computer-readable instructions to:
control traveling of a vehicle on a runway decided on according to first information based on an output of a detection device obtained by detecting a surrounding situation of the vehicle and second information based on map information:
estimate the runway of the vehicle on the basis of the first information and the second information; and
decide on the runway of the vehicle on the basis of the first information, the second information, and runway estimation information about the estimated runway of the vehicle.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a travel controller configured to control traveling of a vehicle on a runway decided on according to first information based on an output of a detection device obtained by detecting a surrounding situation of the vehicle and second information based on map information;
a runway estimator configured to estimate the runway of the vehicle on the basis of the first information and the second information; and
a runway decider configured to decide on the runway of the vehicle on the basis of the first information, the second information, and runway estimation information about the runway of the vehicle estimated by the runway estimator.

2. The vehicle control device according to claim 1, wherein the runway estimator estimates the runway of the vehicle when a deviation degree between the first information and the second information is greater than or equal to a threshold value.

3. The vehicle control device according to claim 1, further comprising a learner configured to generate a runway estimation model in which the first information and the second information are input and the runway estimation information is output on the basis of the first information, the second information, and true value data,
wherein the runway estimator estimates the runway of the vehicle based on the first information and the second information using the runway estimation model.

4. The vehicle control device according to claim 1,
wherein the first information includes information of a first marking for defining a travel lane of the vehicle recognized on the basis of an output of the detection device, and
wherein the second information includes information of a second marking for defining the travel lane of the vehicle acquired from the map information on the basis of position information of the vehicle.

5. The vehicle control device according to claim 1, wherein the runway estimator estimates the runway of the vehicle on the basis of the first information, the second information, and at least one of a travel situation and vehicle model information of the vehicle.

6. The vehicle control device according to claim 2,
wherein the travel controller executes driving control for controlling one or both of steering and a speed of the vehicle,
wherein the driving control includes a first driving mode and a second driving mode having a heavier task imposed on a driver of the vehicle than the first driving mode or having a lower assistance degree for the driver than the first driving mode, and
wherein the travel controller switches the driving mode from the first driving mode to the second driving mode when the deviation degree greater than or equal to a threshold value has continued for a prescribed period of time or more in a state in which the first driving mode is being executed.

7. The vehicle control device according to claim 6, further comprising a notification controller configured to notify a driver of the vehicle of control content in the travel controller,
wherein the notification controller changes content whose notification is provided to the driver in accordance with switching of the driving mode when the deviation degree greater than or equal to the threshold value has continued for the prescribed period of time or more.

8. The vehicle control device according to claim 3, wherein the learner relearns the runway estimation model using the runway of the vehicle estimated by the runway estimator and a runway on which the vehicle has actually traveled.

9. A vehicle control method comprising:
controlling, by a computer, traveling of a vehicle on a runway decided on according to first information based on an output of a detection device obtained by detecting a surrounding situation of the vehicle and second information based on map information;
estimating, by the computer, the runway of the vehicle on the basis of the first information and the second information; and
deciding, by the computer, on the runway of the vehicle on the basis of the first information, the second information, and runway estimation information about the estimated runway of the vehicle.

10. A computer-readable non-transitory storage medium storing a program for causing a computer to:
control traveling of a vehicle on a runway decided on according to first information based on an output of a detection device obtained by detecting a surrounding situation of the vehicle and second information based on map information:
estimate the runway of the vehicle on the basis of the first information and the second information; and
decide on the runway of the vehicle on the basis of the first information, the second information, and runway estimation information about the estimated runway of the vehicle.
